(19) United States
(12) Patent Application Publication
(10) Pub. No.: US 2013/0066790 A1
(43) Pub. Date: Mar. 14, 2013

(54) Residual Value Warranty

(71) Applicants: Julie Ward Drew, Redwood City, CA (US); Jose Luis Beltran Guerrero, Palo Alto, CA (US); Ming Hu, Toronto (CA); Guillermo Gallego, Waldwick, NJ (US); Ruxian Wang, New York, NY (US); Shailendra K. Jain, Cupertino, CA (US)

(72) Inventors: Julie Ward Drew, Redwood City, CA (US); Jose Luis Beltran Guerrero, Palo Alto, CA (US); Ming Hu, Toronto (CA); Guillermo Gallego, Waldwick, NJ (US); Ruxian Wang, New York, NY (US); Shailendra K. Jain, Cupertino, CA (US)

(21) Appl. No.: 13/634,786

(22) PCT Filed: May 30, 2010
(86) PCT No.: PCT/US10/36785

§ 371 Date: Sep. 13, 2012

(51) Int. Cl. G06Q 30/00

(52) U.S. Cl. 705/302

(57) ABSTRACT

A maximum expected value of a residual value warranty for a product to a customer is determined. An expected cost to a provider to support the residual value warranty for the customer is determined, based on the maximum expected value of the candidate residual value warranty to the customer. The expected profitability of the candidate residual value warranty is determined based on the expected cost.

### RELATED APPLICATIONS

The present patent application is related to the previously filed patent US patent application entitled “Product warranties having a residual value.” filed on Jan. 22, 2009, and assigned Ser. No. 12/357,840.

### BACKGROUND

A warranty permits a customer that has purchased or leased a product to have the product repaired or replaced if the product fails during the period of the warranty without having to pay the full costs associated with the repair or replacement. In some situations, the customer may have to pay a deductible each time a claim is submitted against the warranty, whereas in other situations, the customer does not have to pay a deductible. The warranty covers charges for parts, labor, and/or shipping that the customer would otherwise have to pay to repair or replace the product if the product fails.

While many products have manufacturer or other warranties that customers automatically receive when buying the products, a customer may also have the opportunity to purchase or receive an extended warranty. An extended warranty extends the warranty period of the factory warranty for a product, with the same or different terms as the factory warranty. Extended warranties provide customers with additional piece of mind in knowing that any failures of the product that occur after the period of the factory warranty will be at least partially covered during the subsequent period of the extended warranty.

### BRIEF DESCRIPTION OF THE DRAWINGS

FIG. 1 is a flowchart of a method for selecting a residual value warranty with greatest profitability among candidate residual value warranties, according to an embodiment of the disclosure.

FIG. 2 is a flowchart of a system to enable selection of a residual value warranty with greatest profitability, according to an embodiment of the disclosure.

### DETAILED DESCRIPTION OF THE DRAWINGS

As noted in the background section, warranties, including factory warranties and extended warranties, permit a customer who has purchased or leased a product to have the product repaired or replaced if the product fails under warranty without having to pay the full costs associated with the repair or replacement of the product. One type of warranty is known as a residual value warranty. The previously filed US patent application entitled “Product warranties having a residual value,” filed on Jan. 22, 2009, and assigned Ser. No. 12/357,840, describes residual value warranties in detail.

In general, a residual value warranty has a residual value payable back to the customer as a refund at the end of the warranty period, depending on the number of claims that the customer submitted against the warranty during the warranty period. The amount of the refund is based on the number of claims that the customer filed during the warranty period. The more claims that the customer filed, the less the refund is that the customer receives back.

Residual value warranties may or may not have claim limits. A residual value warranty having a claim limit means that a customer can submit a number of claims under the warranty equal to the claim limit. Even if the warranty period has not yet expired, the customer cannot file additional claims against the warranty if he or she has already submitted the maximum number of claims allowed, (Alternatively, the customer can submit claims beyond the limit, but these claims will not be paid for by the provider of the warranty.) The claim limit may be different than the number of claims that can be submitted such that the customer is still entitled to a refund at the end of the warranty period. For example, the claim limit may be ten, such that after the customer has submitted ten claims, no further claims are covered under the warranty. However, once the customer has submitted five claims, the customer may no longer be entitled to a refund at the end of the warranty period.

By comparison, a residual value warranty having no claim limit means that a customer is not limited as to the number of claims that he or she can submit during the warranty period. However, even if a residual value warranty does not have a claim limit, the warranty may still have a limit as, to the number of claims that can be submitted such that the customer is still entitled to a refund at the end of the warranty period. For example, if the customer submits less than five claims, the customer may still be entitled to a refund at the end of the warranty period. If the customer submits five or more claims, the claims are still covered under the warranty, but the customer is not entitled to any refund at the end of the warranty period.

Embodiments of the disclosure provide a manner by which the terms of a residual value warranty can be selected that maximizes the expected profitability of the provider that sells the warranty to customers. The provider may be the manufacturer, distributor, or retailer of the product in question, or another party. In general, different candidate residual value warranties, having different warranty terms, are analyzed to determine their expected profitability. The candidate warranty having the greatest expected profitability is selected for the provider to offer for sale to customers. The warranty terms may include the length of the warranty, the refund schedule of the warranty in correspondence with the number of claims filed, whether the warranty has claim limits, and/or whether the warranty has a deductible, as well as other terms.

More specifically, the maximum expected value of a candidate residual value warranty to a customer is determined. The expected cost to a provider to support the candidate residual value warranty for the customer is then determined based on the maximum expected value, of the candidate warranty to the customer. The expected profitability of the candidate residual value warranty is determined based on the expected cost to the provider. In this way, the expected profitability of each candidate residual value warranty can be determined, so that the candidate warranty having the greatest expected profitability is selected for the provider to offer for sale to customers.

It is noted that as used herein, the terminology repair includes and encompasses the terminology replacement. That is, when a product is to be repaired, in some situations complete replacement of the product may occur. Therefore, for example, the expected cost of repair as used herein means the expected cost of repair or replacement, whichever is more cost effective.

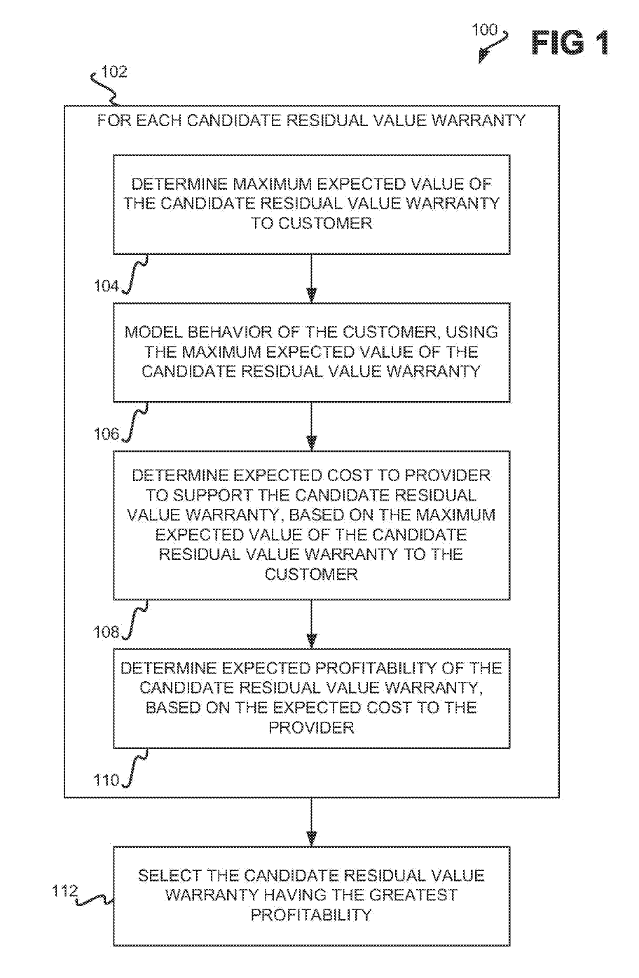

FIG. 1 shows a method 100 for determining a residual value warranty for a provider to offer for sale to customers, according to an embodiment of the disclosure. The method 100 may be performed by a computing device. For example, a computer-readable data storage medium may store one or more computer programs. Execution of the computer programs by a processor of the computing device causes the method 100 to be performed. The computer-readable data storage medium may be a non-volatile data storage medium, such as a hard disk drive or another type of non-volatile medium, or a volatile data storage medium, such as semiconductor memory or another type of volatile medium.

A residual value warranty is said to have a period of coverage of length T. Time is measured backwards, where t specifies the length at time until the residual warranty ends. In one embodiment, it is assumed that failures occur within the product in question in accordance with a non-homogeneous Poisson process having an instantaneous rate λₜ^{u}, where u is an index of a segment of assumed usage of the product by the customer in question. The usage index u may represent any aspect of the customer's usage of the product that may affect its failure rate, such as the rate at which the product is used or the conditions under which it is used, or any other factor that describes its usage. For example, the customer's usage may be average pages printed per month in the case of a printer, or the percentage of hours of utilization in the case of a computer. In the remainder of the patent application, the dependence of the failure process on the usage of the product is dropped, such that the failure rate is referred to as λₜ, where the failure rate is a particular case of the failure process. A failure that occurs with time t remaining in the warranty period has a random repair cost Cₜ, which is the out-of-pocket repair cost incurred by the customer if the customer chooses not to file a claim against the warranty. The expected aggregated failure rate over the period [0,t] is defined as:

$$Λ ( t ) := {\int }_{s = 0}^{t} {λ}_{s} d s , 0 \leq t \leq T ,$$

where λₛ is the instantaneous failure rate for a given usage a of the product by the customer at a given point in time, where the time s is the remaining time within the warranty period.

The residual value warranty is defined as a warranty that has a refund schedule 0≦r₀≦r₁≦ . . . ≦rₙ for a non-negative integer n. A customer who makes 0≦j≦n claims during the warranty period receives a positive refund rₙ₋ⱼ. A customer who makes more than n claims does not receive a refund, but still may be covered under the warranty, depending on whether or not the residual value warranty has a claim limit. As noted above, the customer thus has the option of paying an out-of-pocket cost Cₜ at time t, as noted above, if the customer decides not to claim a particular failure under the warranty.

Furthermore, rⱼ:=0 for all integers j<0.

The method 100 operates by having a number of candidate residual value warranties from which to select a particular warranty that has the greatest profitability to the provider. The selected residual value warranty is the warranty that is offered for sale to customers. The candidate residual value warranties are different warranties in that they have different terms. Such warranty terms can include the price of the warranty, length of the warranty, the refund schedule of the warranty, whether the warranty has claim limits, whether the warranty has a per-claim deductible and the amount of this deductible, as well as other warranty terms.

That a number of different candidate residual value warranties are considered to select a particular residual value warranty to offer for sale to customers by a provider includes two particular scenarios. First, the provider may specify the terms of each of a desired number of different candidate residual value warranties. That is, the provider specifies the number of different candidate residual value warranties from which a particular warranty is to be selected, and also specifies the terms of each candidate warranty. Second, the provider may specify the lower and upper limits to each term, and in one embodiment the amount by which each term can incremented to rise from the lower limit to the upper limit. As such, the number of different candidate residual value warranties is equal to the number of unique combinations of acceptable values of the warranty terms within their limits.

In this latter case, the method 100 may in one embodiment generate the different candidate residual value warranties based on the specifications of the warranty terms as input by the provider. In this approach, the method 100 effectively performs an exhaustive search or another type of search technique to locate the candidate residual value warranty for which the provider will realize the greatest profitability. However, in another embodiment, the method 100 performs a search technique, such as Newton's method, which is, a class of hill-climbing optimization techniques that seek a stationary point of a twice continuously differentiable function. Such a search technique provides optimal values for the warranty terms, within the limits specified by the provider, which maximize the profitability to the provider when profit functions exhibit structural properties such as pseudo-concavity within the warranty parameters, or terms. The method 100 as described herein encompasses both of these embodiments.

For each candidate residual value warranty, the following is performed (102). The maximum expected value of the candidate residual value warranty to a customer is determined (104). The maximum expected value to the customer is determined based on the current time within the period of the residual value warranty, and the number of remaining claims that the customer is entitled to file against the residual value warranty while still being able to receive a refund at the end of the period of the warranty. The maximum expected value is determined further based on the expected value of the refund the customer will receive, minus the out-of-pocket cost incurred by the customer resulting from the customer choosing not to file a claim against the warranty, and the failure process, such as the failure rate, of the product.

As noted above, time is counted backwards, such that t=0 refers to the end of the warranty period. The customer that has usage u of the product chooses to buy the residual value warranty from the provider. The maximum expected value of the warranty to the customer with time t remaining in the warranty period, were k remaining claims can be filed such that the customer still receives a refund at the end of the warranty period, is referred to as g(t,k). Furthermore, λₛ denotes the instantaneous failure rate of the product with time s remaining within the warranty period.

For 1≦k≦n, where n is the total number of claims that the customer is entitled to file while still being able to receive a refund at the end of the period of the warranty,

g(t,k)=λₜδₜE max(g(t−δₜ,k)−Cₜ,g(t−δₜ,k−1))+(1−λₜδₜ)g(t−δₜ,k)+o(δₜ).

In this equation, Cₜ is a random variable representing the out-of-pocket cost that the customer would incur at the current time if the customer chooses to repair the product him or herself in lieu of filing a claim against the warranty. Furthermore, E(•) represents the expected value operator with respect to the random failure cost Cₜ, max(•) is a maximum function, δₜ is an arbitrary period of time, and o(•) is a probability of two or more failures of the product occurring within a time interval (t,t−δₜ]. The boundary conditions to g(t,k) depend on whether there is a claim limit or not. If there is a claim limit, the conditions are g(0,k)=rₖ for k=1, . . . , n and g(t,k)=∫ₛ₌₀^{t}λₛECAₛds for k<0 and 0≦T, whereas if there is no claim limit, the conditions are g(0,k)=rₖ for k=1, . . . , n and g(t,k)=0 for k<0 and 0<t≦T. Taking the limit as δₜ→0,

$$\frac{\partial g ( t , k )}{\partial t} = - {λ}_{t} E min \{ {C}_{t} , Δ g ( t , k ) \} ,$$

In this equation, Δg(t,k):=g(t,k)−g(t,k−1).

The out-of-pocket cost incurred by the customer resulting from the customer choosing not to file a claim against the warranty at the current time is in the most general case random. However, there are two special cases of the out-of-pocket cost. First, the out-of-pocket cost can be considered as constant at any time during the period of the residual value warranty. That is, regardless of the failure in question, it can be assumed in this case that the out-of-pocket cost to repair the product is the same. Second, the out-of-pocket cost can be considered as an exponentially distributed random variable having a stationary (time-invariant) distribution.

In one embodiment, the behavior of the customer can be modeled using the maximum expected value of the candidate residual value warranty to the customer (106). In particular, the behavior of the customer can be modeled as optimal behavior or sub-optimal behavior. The optimal behavior of the customer is to make a claim if there is a failure, and the out-of-pocket cost is greater than the loss in expected value of the residual value warranty to the customer from making a claim. That is, the optimal behavior is to make a claim if there is a failure and Cₜ>Δg(t,k).

One, type of sub-optimal behavior the customer may employ is to make a claim if there is a failure, and the out-of-pocket cost is greater than a predetermined static threshold. In a first scenario, the predetermined static threshold is zero, such that the customer makes a claim every time there is a failure in the product. In a second scenario, the predetermined static threshold is equal to some user-specific amount. In both the first and the second scenarios, the predetermined static threshold may not result in the sub-optimal behavior of the customer approximating the optimal behavior.

By comparison, in a third scenario, the predetermined static threshold results in the sub-optimal behavior of the customer approximating as close as a static threshold can the optimal behavior of the customer. In this scenario, the predetermined static threshold is equal to maxlₐ(a), where max (·) is a maximum function, and a is each of a number of different candidate static thresholds. Furthermore, l(•) is the expected value to the customer of the refund due to the customer at the end of the period of the residual value warranty minus a total out-of-pocket cost incurred by the customer when the customer employs a claim policy with the static threshold a.

Therefore, the behavior of the customer can be modeled sub-optimally or optimally based on the maximum expected value of the candidate residual value warranty. Nevertheless, where the customer's behavior is modeled sub-optimally, his or her behavior can still approximate well the optimal behavior. Part 106 of the method 100 thus illustrates how g(t,k)—i.e., the maximum expected value of a residual value warranty to a customer—can be used for purposes other than selecting which residual value warranty to offer for sale by a provider. Specifically, part 106 models the behavior of the customer based on the maximum expected value of a residual value warranty to a customer, where this behavior modeling may be useful for purposes other than selecting which candidate warranty to offer to customers.

The expected cost to the provider to support the candidate residual value warranty for the customer is determined, based on the maximum expected value of the candidate warranty to the customer (108). This expected cost is specifically the provider's total expected cost to support the warranty for a customer having a particular usage profile of the product for the remaining time within the warranty, when there are a number of remaining claims that can be filed such that the customer still receives a refund at the end of the warranty period. The expected cost is determined also based on the current time within the period of the residual value warranty, on the probability distribution of the out-of-pocket cost incurred by the customer resulting from the customer choosing not to file a claim against the warranty, and on the failure process of the product.

The expected cost is referred to as h(t,k). As noted above, this expected cost of repair is specifically the provider's total cost to support the warranty for a customer having optimal behavior and having usage u for the remaining time t within the warranty when there are remaining claims that can be filed such that the customer still receives a refund at the and of the warranty period. In one embodiment.

h(t,h)=h(t−δₜ,k)+λₜδₜPr(Cₜ>Δg(t,k)){βE[Cₜ|Cₜ>Δg(t,k)]−Δh(t−δₜ,k)}+o(δₜ).

The function h(t,k) can be calculated by using a discretization process of dynamic pro-ramming recursion, or in some situations, by using a closed form solution.

In the equation for h(t,k), Δh(t,k):=h(t,k)−h(t,k−1), Δg(t,k):=g(t,k)−g(t,k−1), E(•) represents the expected value operator with respect to the random failure, cost Cₜ, δₜ: is an arbitrary period, of time, and o(•) is a probability of two or more failures of the product occurring within a time interval (t,t−δₜ]. Furthermore, for the repair that has the out-of-pocket cost to the customer Cₜ, the manufacturer is assumed to incur a corresponding cost βCₜ to make the same repair, where 0<β<1. For most repairs, then, the customer pays more to have a product repaired or replaced than the provider does.

Taking the limit as δₜ→0.

$$\frac{\partial h ( t , k )}{\partial t} = {λ}_{t} Pr ( {C}_{t} > Δ g ( t , k ) ) \{ β E [ {C}_{t} \vert {C}_{t} > Δ g ( t , k ) ] - Δ h ( t , k ) \} .$$

The boundary conditions are h(0,k)=rₖ for 0≦k≦n and h(t,k)=0 for k<0 and 0≦t≦T when there is a claim limit; and h(0,k)=rₖ for 0≦k≦n and h(t,k)=β∫ₛ₌₀^{t}λₛECₛds for k<0 and 0≦t≦T when the is no claim limit. Also, as noted above, the out-of-pocket cost incurred by the customer resulting from the customer choosing not to file a claim against the warranty at the current time is in the most general case random.

However, in one special case, the out-of-pocket cost can be considered constant, C. In this case.

h(T,n)=β[g(T,n)+Λ(T)C]+(1−β)z(T,n)

Here, h(T,n) is the total expected cost to the provider to support the residual value warranty over the entire period of the warranty T, assuming that the customer still has n unified claims that the customer could have filed against the warranty during the period T and still have received a refund. Furthermore, C is the constant out-of-pocket repair cost, Λ(T) is the expected aggregated failure rate of the product over the entire warranty period, and z(T,n) is the customer's expected refund from the time of the start of the warranty period (with time T remaining in the warranty period) when the customer can make up to n claims and still receive a refund and satisfies:

$$z ( t , k ) = \{ \begin{matrix}{r}_{k} & if 0 \leq t \leq {t}_{k} \\ {\sum }_{j = 0}^{k} {r}_{j} {e}^{- {Λ}_{j} ( t )} {Λ}_{j , k} ( t ) & if t > {t}_{k}\end{matrix}$$

Furthermore, tₖ represents a time threshold such that it is optimal to claim a failure with k claims remaining only if the remaining time in the warranty period its at least tₖ and Λⱼ(t)=∫ₜ^{t}λₛds is the expected aggregated failure rate of the product from when time t is remaining in the warranty period until time tⱼ. Also, Λ_{j,k}(t)=∫ₜ_{ₖ}^{t}Λ_{j,k-1}(s)ds for t≧tⱼ and Λ_{k,k}(t)=1 for t≧tₖ. As before, rⱼ is the refund provided by the residual value warranty after j claims have been submitted.

In another special case, the out-of-pocket cost can be considered as an exponentially distributed random variable with parameter v, and thus the expected value of the out-of-pocket repair cost is 1/v. In this case,

$$h ( t , k ) = β [ g ( t , k ) + Λ ( T ) EC ] + ( 1 - β ) \frac{{\sum }_{j = 0}^{k} {Q}_{k - j} P ( t , j )}{1 + {\sum }_{j = 0}^{k} {R}_{k - j} P ( t , j )}$$

Here, P(t,j)=Pr(N(t)=j), where N(t) is a Poisson random variable with parameter Λ(t). Furthermore, Qₖ₋ⱼ:=rₖ₋ⱼe^{v·r}^{ₖ₋ⱼ} and Rₖ₋ⱼ:=e^{v·r}^{ₖ₋ⱼ}−1 for (k−j)ε{0, 1, . . . , n}, where rₖ₋ⱼ is the refund provided by the residual value warranty after k−j claims have been submitted.

The expected profitability of the candidate residual value warranty from a given customer who buys the residual value warranty is then determined, based on the expected cost to the provider (110). That is, the expected profitability is determined based on the provider's total cost to support the warranty for the customer. The expected profitability from a customer who buys the residual value warranty is equal to the price paid by the customer for the residual value warranty in question, minus the expected cost to the provider to support the residual value warranty over the warranty period given a usage of the product by the customer and given a number of claims that the customer could have filed against the warranty while still being able to receive a refund at the end of the warranty period.

The expected profitability from a single customer who buys the residual value warranty is referred to as Z(u) where u is the usage of the product by the customer. Specifically,

Z(u)=p−h(T,n).

In this equation h(T,n) is the total expected cost to the provider to support the residual value warranty for the customer who buys it over the entire period of the warranty T, assuming that the customer still has n unfiled claims that the customer could have filed against the warranty during the period T and still have received a refund. In addition, p is, the price that the customer paid for the warranty. The average expected profitability over population of potential customers can be represented by:

$$X = E [ Z ( U ) Π ( U ) ] = {\int }_{u} Z ( u ) Π ( u ) q ( u ) d u .$$

where E(•) represents the expected value operator with respect to the random failure cost Cₜ, and U is a random variable representing the usage rate of a randomly selected customer from the population. Furthermore, Π(u) is a function describing the probability that a customer with usage rate u will choose to buy the residual value warranty among other service alternatives available in the market, and where q(u) represents the fraction of the potential customer population that has usage rate u.

It is noted that part 110 of the method 100 illustrates how h(t,k)—i.e., the expected cost to the provider to support the warranty with time t remaining in the warranty period where the customer can file k claims and still receive a refund—can be used for purposes other than selecting which residual value warranty to offer for sale by a provider. Specifically, part 110 determines the expected profitability of a residual value warranty based on the expected cost to the provider. This expected profitability may be useful for purposes other than selecting which candidate warranty to offer to customers.

Once part 102 has been performed for each candidate residual value warranty, the candidate residual value warranty that has the greatest profitability is selected (112) to offer for sale, to customers of the product. That is, the candidate residual value warranty having the greatest average expected profit per customer X is selected. In one embodiment, this is equivalent to selecting the warranty terms for a residual value warranty, specifically the warranty price p and the refund schedule (r₁, . . . , rₙ) to maximize the average expected profit per customer X.

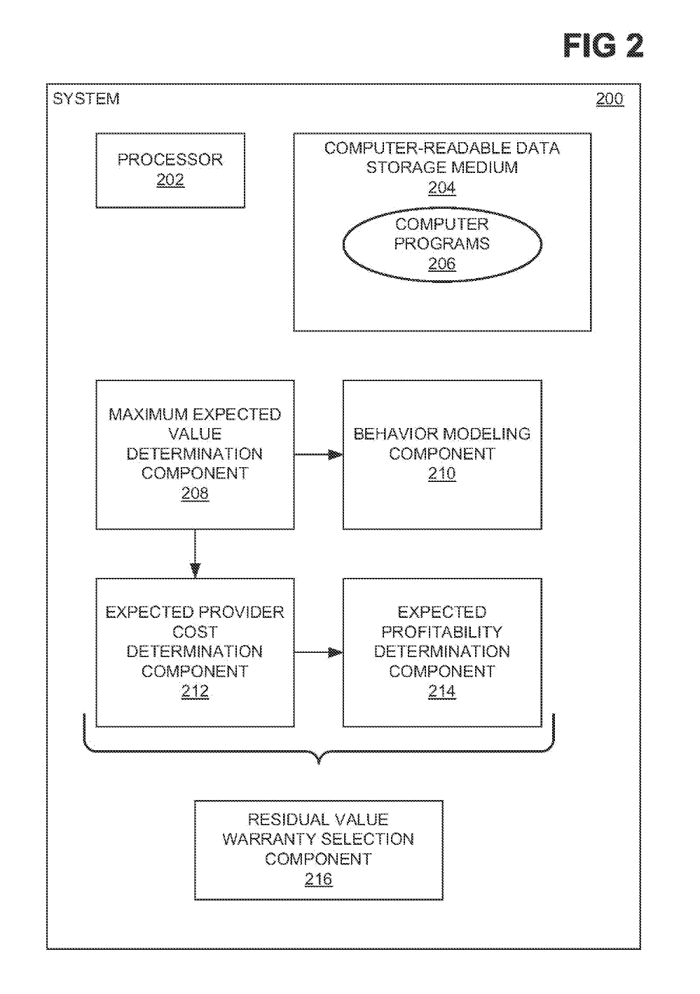

FIG. 2 shows a representative system 200, according to an embodiment of the disclosure. The system 200 includes a processor 202 and a computer-readable data storage medium 204. The system 200 may include other hardware in addition to the processor 202 and the computer-readable data storage medium 204. The computer-readable data storage medium 204 may be a non-volatile data storage medium, such as a hard disk drive, a volatile data storage medium, such as a semiconductor memory, and/or another type of computer-readable data storage medium.

The computer-readable data storage medium 204 stores one or more computer programs 206 that are executable by the processor 202. The system 200 includes components 208, 210, 212, 214, and/or 216 that are said to be implemented by the computer programs 206. This is because execution of the computer programs 206 by the processor 202 from the computer-readable data storage medium 204 results in the performance of the various functionality of the components 208, 210, 212, 214, and/or 216.

The component 208 is a maximum expected value determination component, which performs part 104 of the method 100 to determine the maximum expected value of a residual value warranty to a customer. The components 210 and 212 are communicatively interconnected to the component 208. The component 210 is a behavior modeling component, which performs part 106 of the method 100 to model the behavior of the customer using the maximum expected value that the component 208 has determined. The component 212 is an expected provider cost determination component, which performs part 108 of the method 100 to determine the expected cost to a provider to support the residual value warranty for the customer, based on the maximum expected value that the component 208 has determined.

The component 214 is communicatively interconnected to the component 212. The component 214 is an expected profitability determination component, which performs part 110 of the method 100 to determine the expected profitability of the residual value warranty to the provider, based on the expected provider cost that the component 212 has determined. The component 216 is a residual value warranty selection component. The component 216 performs parts 102 and/or 112 of the method 100 in one embodiment. For example, the component 216 can cause the components 208, 210, 212, and/or 214 to perform the respective functionality as to each of a number of different candidate residual value warranties. The component 216 then selects the candidate residual value warranty having the greatest expected profitability determined by the component 4, as the warranty for the provider to offer for sale to customers.

We claim:

1. A method comprising:
for each candidate residual value warranty for a product of a plurality of different candidate residual value warranties for the product,
determining, by a computing device, a maximum expected value of the candidate residual value warranty to a customer;
determining, by the computing device, an expected cost to a provider to support the candidate residual value warranty for the customer, based on the maximum expected value of the candidate residual value warranty to the customer;
determining, by the computing device, an expected profitability of the candidate residual value warranty based on the expected cost to the provider; and,
selecting, by the computing device, the candidate residual value warranty that has a greatest expected profitability to offer to the customer.

2. The method of claim 1, wherein determining the maximum expected value and the expected cost are each based at least on:
a current time within a period of the residual value warranty;
a number of remaining claims that the customer is entitled to file against the residual value warranty while still being able to receive a refund at an end of the period of the residual value warranty;
an out-of-pocket cost incurred by the customer resulting from the customer choosing not to file a claim against the residual value warranty at the current time; and,
a failure process of the product at the current time.

3. The method of claim 2, wherein determining the maximum expected value of the candidate residual value warranty comprises determining the maximum expected value of the residual value warranty at the current time with the number of remaining claims as a solution g(t,k) characterized by
$$\frac{\partial g ( t , k )}{\partial t} = - {λ}_{t} E min \{ {C}_{t} , Δ g ( t , k ) \} .$$
where t is the current time, k is the number of remaining claims that the customer is entitled to file against the residual value warranty while still being able to receive a refund at the end of the period of the residual value warranty, Cₜ is the out-of-pocket cost at the current time, λₜ represents the failure process at the current time, E is an expected value operator with respect to the out-of-pocket cost, min( ) is a minimum function, and Δg(t,k):=g(t,k)−g(t,k−1).

4. The method of claim 2, wherein determining the expected cost comprises determining the expected cost at the current time with the number of remaining claims as a solution h(t,k) characterized by
$$\frac{\partial h ( t , k )}{\partial t} = {λ}_{t} Pr ( {C}_{t} > Δ g ( t , k ) ) \{ β E [ {C}_{t} \vert {C}_{t} > Δ g ( t , k ) ] - Δ h ( t , k ) \} ,$$
where t is the current time, k is the number of remaining claims, Cₜ is the out-of-pocket cost at the current time, λₜ is the failure rate at the current time, Δg(t,k):=g(t,k)−g(t,k−1), g(t,k) is the maximum expected value of the residual value warranty to the customer at the current time with the number of claims remaining, E is an expected value operator with respect to the out-of-pocket cost, Pr(•) is a probability function, β is a parameter such that βCₜ is a cost for the provider to repair the product, and Δh(t,k):=h(t,k)−h(t,k−1).

5. The method of claim 2, wherein the out-of-pocket cost is one of:
constant at any time during the period of the residual value warranty; and,
an exponentially distributed random variable.

6. A computer-readable data storage medium having a computer program stored thereon for execution by a processor, execution of the computer program by the processor causing a method to be performed, the method comprising:
determining a maximum expected value of a residual value warranty for a product to a customer; and,
modeling behavior of the customer by using the maximum expected value of the residual value warranty to the customer that has been determined.

7. The computer-readable data storage medium of claim 6, wherein determining the expected value of the residual value, warranty to the customer is based at least on:
a current time within a period of the residual value warranty;
a number of remaining claims that the customer is entitled to file against the residual value warranty while still being able to receive a refund at an end of the period of the residual value warranty;
an out-of-pocket cost incurred by the customer resulting from the customer choosing not to file a claim against the residual value warranty at the current time; and,
a failure process of the product at the current time.

8. The computer-readable data storage medium of claim 7, wherein determining the maximum expected value of the candidate residual value warranty comprises determining the maximum expected value of the residual value warranty at the current time with the number of remaining claims as a solution g(t,k) characterized by
$$\frac{\partial g ( t , k )}{\partial t} = - {λ}_{t} E min \{ {C}_{t} , Δ g ( t , k ) \} ,$$
where t is, the current time, k is the number of remaining claims that the customer is entitled to file against the residual value warranty while still being able to receive a refund at the end of the period of the residual value warranty, Cₜ is the out-of-pocket cost at the current time, λₜ represents the failure process at the current time, E is an expected value operator with respect to the out-of-pocket cost, min( ) is a minimum function, and Δg(t,k):=g(t,k)−g(t,k−1).

9. The computer-readable data storage medium of claim 7, wherein modeling the behavior of the customer by using the maximum expected value of the residual value warranty that has been determined comprises:
modeling the behavior of the customer as optimal behavior, where the customer is to make a claim if there is a failure and the out-of-pocket cost is greater than a loss in the expected value of the residual value warranty to the customer resulting from the customer making a claim.

10. The computer-readable data storage medium of claim 7, wherein modeling the behavior of the customer by using the maximum expected value of the residual value warranty that has been determined comprises:
modeling the behavior of the customer as a sub-optimal behavior, where the customer is to make a claim if there is a failure and the out-of-pocket cost is greater than a predetermined static threshold,
wherein the predetermined static threshold is selected from:
a first predetermined static threshold equal to zero;
a second predetermined static threshold equal to a user-specified amount; and,
a third predetermined static threshold equal to
$${max}_{a} I ( a ) ,$$
where max(•) is a maximum function, a is each of a plurality of candidate thresholds, and l(•) is an expected refund due to the customer at the end of the period of the residual value warranty minus a total out-of-pocket cost incurred by the customer when the customer chooses not to file claims below a threshold a against the residual value warranty during the period of the residual value warranty, where a specifies the threshold.

11. A system comprising:
a processor;
a computer-readable data storage medium to store a computer program executable by the processor; and,
a first component implemented by the computer programs to determine an expected cost to a provider to support a residual value warranty for a customer; and,
a second component implemented by the computer programs to determine an expected profitability of the residual value warranty based on the expected cost.

12. The system of claim 11, wherein the first component is to determine the expected cost based at least on:
a current time within a period of the residual value warranty;
a number of remaining claims that the customer is entitled to file against the residual value warranty while still being able to receive a refund at an end of the period of the residual value warranty;
an out-of-pocket cost incurred by the customer resulting from the customer choosing not to file a claim against the residual value warranty at the current time;
a failure process of the product at the current time; and,
an expected value of the residual value warranty to the customer at the current time with the number of claims remaining.

13. The system of claim 12, wherein the first component is to determine the expected cost at the current time with the number of remaining claims as a solution h(t,k) characterized by
$$\frac{\partial h ( t , k )}{\partial t} = {λ}_{t} Pr ( {C}_{t} > Δ g ( t , k ) ) \{ β E [ {C}_{t} \vert {C}_{t} > Δ g ( t , k ) ] - Δ h ( t , k ) \} ,$$
where t is the current time, k is the number of remaining claims, Cₜ is the out-of-pocket cost at the current time, λₜ is the failure rate at the current time, Δg(t,k):=g(t,k)−g(t,k−1), g(t,k) is the maximum expected value of the residual value warranty to the customer at the current time with the number of claims remaining, E is an expected value operator with respect to the out-of-pocket cost, Pr(•) is a probability function, β is a parameter such that βCₜ is a cost for the provider to repair the product, and Δh(t,k):=h(t,k)−h(t,k−1).

14. The system of claim 12, wherein the second component is to determine the expected profitability of the residual value warranty from the customer who purchases the residual value warranty based on the expected cost of repair as equal to a price paid by the customer for the residual value warranty, minus the expected cost to the provider to support the warranty for the customer over the period of the residual value warranty given a usage of the product by the customer and given a number of claims that the customer was still entitled to file against the residual value warranty while still being able to receive the refund at the end of the period of the residual value warranty.

15. The system of claim 12, wherein the out-of-pocket cost is one of:
constant at any time during the period of the residual value warranty; and,
an exponentially distributed random variable.
